(19) United States
(12) Patent Application Publication
(10) Pub. No.: US 2026/0320410 A1
(43) Pub. Date: Oct. 15, 2026

(54) DYNAMIC CLUSTERING AND PARALLELIZED MACHINE LEARNING FOR DECENTRALIZED SYSTEMS

(71) Applicant: DELL PRODUCTS L.P., Round Rock, TX (US)

(72) Inventors: Saurabh Jha, Austin, TX (US); Kailash Talreja, Mumbai (IN); Shashank Kapoor, Bengaluru (IN)

(21) Appl. No.: 19/174,660

(22) Filed: Apr. 9, 2025

(51) Int. Cl. G06N 3/098; G06N 3/092

(52) U.S. Cl. CPC G06N 3/098; G06N 3/092

(57) ABSTRACT

An intelligent agent node may operate within a decentralized machine learning environment. The intelligent agent node includes a processor and an input/output interface coupled with the processor to communicate via a peer-to-peer network with other intelligent agent nodes. The intelligent agent node self-organizes with at least one of the other intelligent agent nodes into a cluster of intelligent agent nodes based, in part, on determining a similarity metric for each member of the cluster. The intelligent agent node also trains a local deep neural network based on local machine-generated data and exchange deep neural network parameters with other members of the cluster as part of intra-cluster parallelized training of an aggregated deep neural network, which in combination with other aggregated deep neural networks generated by members of other clusters forms a global deep neural network.

### FIELD OF THE DISCLOSURE

The present disclosure generally relates to information handling systems, and more particularly relates to implementing machine learning across a decentralized system of multiple information handling systems.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An intelligent agent node may operate within a decentralized machine learning environment. The intelligent agent node includes a processor and an input/output interface coupled with the processor to communicate via a peer-to-peer network with other intelligent agent nodes. The intelligent agent node may self-organize with at least one of the other intelligent agent nodes into a cluster of intelligent agent nodes based, in part, on determining a similarity metric for each member of the cluster. The intelligent agent node may also train a local deep neural network based on local machine-generated data and exchange deep neural network parameters with other members of the cluster as part of intra-cluster parallelized training of an aggregated deep neural network, which in combination with other aggregated deep neural networks generated by members of other clusters forms a global deep neural network.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a decentralized learning system that includes multiple intelligent agent nodes implemented, each implemented in a distinct information handling system according to at least one embodiment of the present disclosure;

FIG. 2 is a schematic representation of clusters of intelligent agent nodes dynamically generated the decentralized learning system of FIG. 1 according to at least one embodiment of the present disclosure;

FIG. 3 is a schematic representation of clusters of intelligent agent nodes dynamically generated by the decentralized learning system of FIG. 1 according to at least one embodiment of the present disclosure;

FIG. 4 is a schematic representation of feedback between generalist and specialist intelligent agent nodes dynamically generated the decentralized learning system of FIG. 1 according to at least one embodiment of the present disclosure;

FIG. 5 is a schematic representation of clusters of intelligent agent nodes dynamically generated the decentralized learning system of FIG. 1 according to at least one embodiment of the present disclosure;

FIG. 6 is a flow diagram of a method for decentralized machine learning according to at least one embodiment of the present disclosure; and

FIG. 7 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

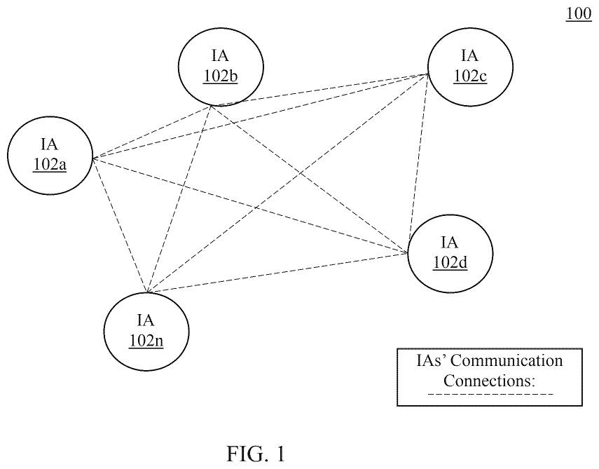

FIG. 1 illustrates a decentralized learning system 100 according to at least one embodiment of the present disclosure. Illustratively, decentralized learning system 100 includes multiple intelligent agent nodes 102a, 102b, 102c, and 102d through 102n, where n is a positive integer. Within decentralized learning system 100, intelligent agent nodes 102a-102n are configured to operate cooperatively and dynamically without a central controller. Intelligent agent nodes 102a-102n self-organize into clusters based on real-time metrics, such as data distribution, resource availability, and/or other similarity measures. As configured, each intelligent agent node 102a-102n is capable of training a local machine learning model such as a deep neural network and using the local model to generate inferences or predictions (e.g., classification, regression) during an inference or test-time phase.

Intelligent agent nodes 102a-102n are further configured to fine tune the local models through intra-cluster parallelized training. With intra-cluster parallelized training, intelligent agent nodes 102a-102n exchange model parameters asynchronously with other members of the same cluster and generate aggregated machine learning models. Intra-cluster parallelized training uses weighted aggregation of shared parameters to account for data sizes and/or computational capacities of the individual intelligent agent nodes within each cluster. With weighted aggregation, those intelligent agent nodes training models on larger datasets or having relatively more computational capabilities contribute proportionally more to model aggregation.

During inference phases, intelligent agent nodes 102a-102n may reorganize based on newly collected data giving rise to different similarity metrics. Thus, unlike the static configuration of clustered federated learning (CFL), the clusters of intelligent agent nodes 102a-102n may be continuously, or intermittently, evaluated and reorganized by agents in response to data drift, agent drop-out, shifts in computational resources, and/or other factors. Intelligent agent nodes 102a-102n are configured to leverage inference-phase data to dynamically reorganize clusters to enhance inter-agent collaboration. In certain models, intelligent agent nodes within a cluster are further configured to construct a hierarchy of generalist and specialist machine learning models. A global machine learning model may be generated by aggregating, across clusters, the refined generalist and specialized models generated by intelligent agent nodes 102a-102n. The global model thus incorporates broad generalizations of general models and targeted insights of the specialist models.

Each intelligent agent node 102a-102n may be implemented in an information handling system capable of storing executing machine-readable code to train a machine learning model (e.g., deep neural network) and to use the trained model to generate inferences (e.g., classifications, regressions). For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen, and/or a video display. The information handling system may also include one or more buses operable to transmit communications between the various hardware components.

Referring still to FIG. 1, the information handling systems in which intelligent agent nodes 102a-102n are implemented may be configured to communicate with one another via wired and/or wireless connections without a central server or other centralized device. Each intelligent agent node 102a-102n is configured to act as both a client and a server for sharing data, processing resources, data storage, and the like. In certain embodiments, the respective information handling systems in which intelligent agent nodes 102a-10n are implemented may be servers (e.g., edge servers). In other embodiments, the information handling systems may be devices communicatively coupled to a local area network (LAN) or platform, such as that of a healthcare, finance, or other organization. The information handling systems, in still other embodiments, may include Internet-of-Things (IoT) devices, each having data processing and data storage capabilities for executing machine-readable code (program instructions) to train a machine learning model and generate inferences with the trained model.

In these and various other embodiments, intelligent agent nodes 102a-102n are configured to collect machine-generated data. Machine-generated data, for example, may be data generated by a software or other tool that generates metrics tracking the performance of the information handling system that implements an intelligent agent node. The machine-generated data, in other embodiments, may include data generated by one or more sensors operatively coupled with the information handling that implements an intelligent agent node. In each of the various embodiments, intelligent agent nodes 102a-102n use the machine-generated data to train a machine learning model and to generate real-time inferences with the trained model.

In performing intra-cluster parallelized training, each intelligent agent node 102a-102n initially generates a local machine learning model based on the machine-generated data and refines the model by exchanging model parameters with other members of the same cluster. In some embodiments, a weighted aggregation of each cluster members' respective model parameters is generated to create a cluster-specific machine learning model. The aggregated models of each of the distinct clusters, in such embodiments, may be combined to generate the global model. In certain embodiments, in which intelligent agent nodes 102a-102n are implemented by edge servers deployed in geographically dispersed datacenters, for example, the global model may be trained to predict system failure. For example, in the context of a healthcare organization, the global model may be trained to classify medical imaging data. In the context of a financial organization the global model, for example, may be trained to detect fraud.

In these and various other embodiments, the dynamic clustering of intelligent agent nodes 102a-102n enables agents encountering similar data distributions and/or having similar resource capabilities to collaborate more closely within a distinct cluster. Within each cluster, parallelized learning improves decentralized learning system 100's scalability and reduces communication delays by enabling local, intra-cluster machine learning while simultaneously maintaining model convergence across decentralized learning system 100. Moreover, during real-time inference phases, newly collected data not previously encountered or indicating an evolving pattern may be collected and flagged for updating one or more local machine learning models. Incorporating updates into updating aggregated models creates a feedback loop between model training and inference generating, enhancing overall performance of the models in the face of newly collected data.

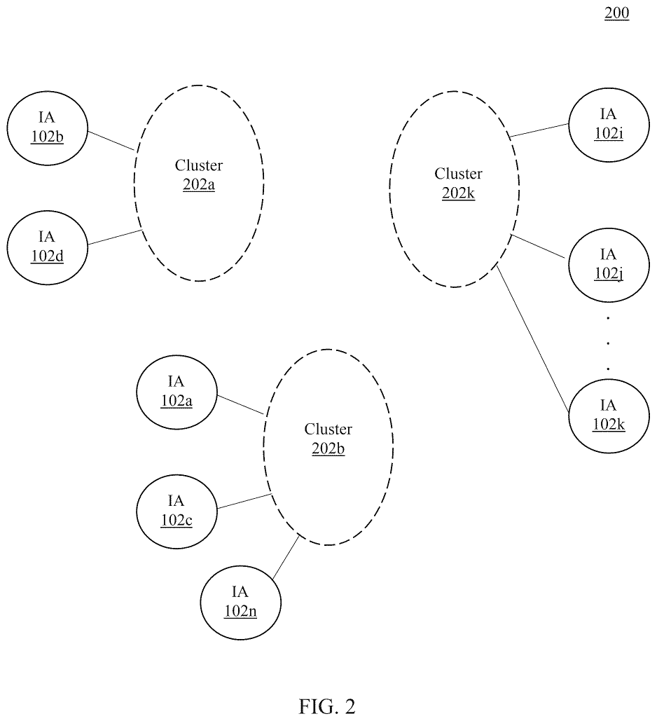

FIG. 2 schematically illustrates dynamic clustering 200 in which intelligent agent nodes 102a-102n of decentralized learning system 100 are configured to self-organize into distinct clusters 202a and 202b through 202m, where m is a positive integer, according to at least one embodiment of the present disclosure. Each cluster 202a-202m includes two or more intelligent agent nodes. Intelligent agent nodes 102a-102n, in various embodiments, are configured to self-organize into clusters based on one or more similarity metrics. In various arrangements, the one or more similarity metrics may measure data similarity, computational performance or capacity, and/or other factors. Each intelligent agent node 102a-102n is configured to initially collect local data, which is machine-generated. The machine-generated data is generated internally by the information handling system in which an agent is implemented or is obtained through an I/O interface between the information handling system and another device such as a sensor. The local data collected by each intelligent agent node 10a-102n is preprocessed by the information handling system and stored in a predetermined structural format for implementing dynamic clustering. The structured format may be an n-element vector for training a deep neural network.

For example, in certain embodiments intelligent agent nodes 102a-102n are individually implemented in individual edge servers deployed in geographically dispersed datacenters. The machine-generated data collected by each intelligent agent node corresponds to hardware metrics generated internally by the server in which the intelligent agent node is implemented to monitor server performance. The hardware metrics, for example, may include CPU utilization, memory consumption, and disk error rates. Each server may store the machine-generated data in a lightweight database, or a schema-based data structure optimized for efficient access. In other embodiments, diverse local data collected by respective intelligent agent nodes in heterogeneous environments may be standardized to facilitate collaborative learning among intelligent agent nodes 102a-102n.

Intelligent agent nodes 102a-102n, in certain embodiments, may be configured to self-organize into clusters 202a-202m based on pairwise similarities between each pair of intelligent agent nodes 102a-102n. For example, in some embodiments, the pairwise similarity is measured by the cosine similarity, CS, between the respective machine-generated data collected by each pair of intelligent agent nodes, and the machine-generated data configured as feature vectors. CS is determined as the dot product of feature vectors \tilde{x}ᵢ and \tilde{x}ⱼ of machine-generated data collected by the i-th and j-th intelligent agent nodes, respectively, and divided by the respective norms ∥\tilde{x}ᵢ∥ and ∥\tilde{x}ⱼ∥ of the feature vectors.

$$C S ( i , j ) = \frac{{\overline{x}}_{i} \cdot {\overline{x}}_{j}}{‖ {\overline{x}}_{i} ‖ ‖ {\overline{x}}_{j} ‖} . \qquad EQ . 1$$

The k-th cluster, Cₖ, among clusters 202a-202m is formed based on a predetermined similarity threshold, τ:

Cₖ={i:CS(i,j)≥τ,∀j∈Cₖ}; EQ. 2

that is, cluster Cₖ includes all intelligent agent nodes whose cosine similarities with every other intelligent agent node contained in the cluster are equal to or greater than the similarity threshold.

In other embodiments, intelligent agent nodes 102a-102n may be configured to measure their respective similarities based on distributions of the data used by each for training a machine learning model. Data distribution similarity may be measured by Kullback-Leibler (KL) divergence, or relative entropy, a statistical measure quantifying the difference between two probability distributions of different sets of machine-generated data. In other embodiments, in which the local models trained by intelligent agent nodes 102a-102n, the agents may be configured to measure gradient similarity among gradients generated in performing stochastic gradient descent. Intelligent agent nodes 102a-102n that consistently produce similar gradient updates are likely to share similar learning representations and thus may be clustered together.

In yet other embodiments, intelligent agent nodes 102a-102n may be configured to measure their respective similarities based on inference-phase performance and cluster based on how each agent's model performs on newly collected data. For example, if two agents generate machine learning models that exhibit similar misclassification trends, the two agent are clustered for future model updates to correct the similar misclassifications.

In still other embodiments, intelligent agent nodes 102a-102n, may be configured to perform dynamic clustering 200 based on resource availability and/or capacity (e.g., computational capacity and/or communication bandwidth). Initially, each cluster, Cₖ, among clusters 202a-202m is formed based on the similarity of machine-generated data locally collected by each intelligent agent node. Given that each intelligent agent node 102a-102n is implemented in an individual information handling system, however, the collective resources of the information handling systems supporting the members of the cluster may not be sufficient for efficiently performing the intra-cluster parallelized training of a machine learning model. If the total resource demand of the cluster, Cₖ, exceeds a threshold, Rₘₐₓ, then the members of the cluster are split into two or more clusters based on a resource ranking, rᵢ. For example, if for the cluster, Cₖ, the information handling system in which the intelligent agent nodes are implemented are servers (e.g., edge servers), then the resource ranking, rᵢ, of the i-th member of cluster may be CPU speed, memory availability, or another hardware-related metric. Based on the resource rankings, the initial composition of members of cluster, Cₖ, is split into two or more separate clusters.

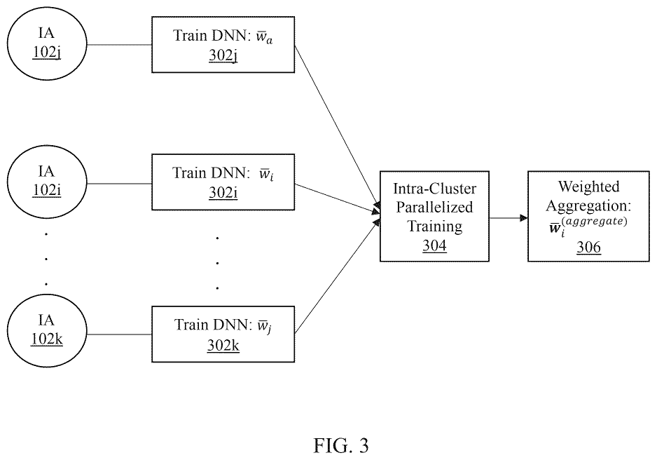

FIG. 3 schematically illustrates intra-cluster parallelized training 300 in which intelligent agent nodes 102i and 102i through 102k within cluster 202k update or refine their respective machine learning models, deep neural networks 302i and 302j through 302k according to at least one embodiment of the present disclosure. Each member of a cluster may randomly initialize the parameters (or use ones from previously generated models) to generate its own local machine learning model and then iteratively revise the parameters in training the local model based on local machine-generated data collected by the member. As members of a cluster, each intelligent agent node asynchronously exchanges model parameters with the other members of the cluster. Model training coupled with exchanging parameters among agents facilitates training an aggregated model (e.g., deep neural network) through intra-cluster parallelized training 304. The model parameters are aggregated to generate an aggregated machine learning model, deep neural network 306, for the i-the intelligent agent node. In certain embodiments described below in which each aggregated model is specific to each intelligent agent node of a single cluster, the intelligent agent nodes within the cluster may be further configured to generate a hierarchy in which one or more agents' models are generalist models and one or more other agents' models are specialist models. In other embodiments, an aggregated machine learning model specific to the entire cluster may be generated and the model's parameters may be combined with those of other cluster-specific models to create a global machine learning model.

In training models, if cluster Cₖ contains nₖ intelligent agent nodes as its members, then the i-th intelligent agent node trains its local model on local machine-generated dataset,

$${𝒟}_{i} = {\{ ( {\overline{x}}_{i}^{( l )} , {y}_{i}^{( l )} ) \}}_{l}^{{m}_{i}} ,$$

in which mᵢ is the number of data samples contained in the dataset, in which

$${\overline{x}}_{i}^{( l )}$$

is a feature vector representing local machine-generated data, and in which

$${y}_{i}^{( j )}$$

is an example target value for training the intelligent agent node's local machine learning model. If the machine learning model is a deep neural network, the model has an input layer, multiple hidden layers, and an output layer. Inputs to each layer are linearly weighted by parameters \tilde{w}ᵢ and fed into a non-linear activation function. The model is trained by minimizing a loss function, [symbol] ᵢ, by iteratively adjusting the parameters w̅ᵢ (a vector) over T iterations. Using stochastic gradient descent, the parameters for each layer are adjusted at iteration t∈T according to the following procedure:

$${\overline{w}}_{i}^{( t )} = {\overline{w}}_{i}^{( t - 1 )} - η {∇}_{{\overline{w}}_{i}} {ℒ}_{i} ( {\overline{w}}_{i} , {𝒟}_{i} ) , \qquad EQ . 3$$

where ∇_{\tilde{w}}_{ᵢ}, is the gradient of the loss function with respect to the parameters and η is a preselected learning rate.

Configured to perform intra-cluster parallelized training, the intelligent agent nodes of each cluster 202a-202m aggregate the parameters exchanged with one another according to the following procedure:

$${\overline{w}}_{i}^{( aggregate )} = {\sum }_{j ∈ {C}_{k}} {α}_{ij} {\overline{w}}_{j} , \qquad EQ . 4$$

where

$${α}_{ij} = \frac{{m}_{i}}{{\sum }_{j ∈ {C}_{k}} {m}_{j}}$$

is the ratio of the number of local model training samples used by the i-th member relative to sum of samples for the total number of members of the k-th cluster, Cₖ. Accordingly, the deep neural network parameters of each aggregated deep neural network are determined as a weighted sum of the deep neural network parameters of the machine learning models generated by each member of a cluster.

Intelligent agent nodes 102a-102n allocated among the various clusters 202a-202k may each periodically fine-tune their machine learning model (e.g., deep neural network) in response to previously unencountered machine-generated data or a newly evolving data pattern encountered when generating inferences with the model as previously trained. In certain embodiments, each intelligent agent node 102a-102n computes and stores statistics for each feature of the feature vectors representing the machine-generated data. For example, with data samples whose probability distribution is assumed to be identically independently distributed (iid) as Gaussian random variables, [symbol] (μ, σ²), an intelligent agent node may be configured to detect whether the sample variance of newly collected machine-generated data is greater than a predetermined number of standard deviations. In response to detecting the greater-than-specified maximum standard deviations, the intelligent agent node is configured to respond by updating its machine learning model. Thus, if the model is a deep neural network, then a new set of parameters w̅ is generated based on the newly collected data.

As configured, each intelligent agent node 102a-102n is capable of fine-tuning its local machine learning model with newly collected data. For a deep neural network, an intelligent agent node performs stochastic gradient descent using a dataset

$${𝒟}_{i}^{( new )} = {\{ ( {\overline{x}}_{i}^{( j )} , {y}_{i}^{( j )} ) \}}_{j}^{{{m}^{′}}_{i}} :$$

$${\overline{w}}_{i}^{( t )} = {\overline{w}}_{i}^{( t - 1 )} - η {∇}_{{\overline{w}}_{i}} {ℒ}_{i} ( {\overline{w}}_{i} , {𝒟}_{i}^{( new )} ) , \qquad EQ . 5$$

where \acute{m}ᵢ is the number of newly collected data samples and

$${\overline{x}}_{i}^{( j )}$$

is the feature vector representing local machine-generated data used to fine-tune the machine learning model. Note the i-the intelligent agent node as a member of the k-th cluster, Cₖ, is capable of adjusting its model's parameters w̅ᵢ asynchronously and in real-time without requiring global synchronization. Each intelligent agent node 102a-102n may also be configured to share updates of its model parameters with each other member of the same cluster. Inter-cluster parallelized learning 300 coupled with one intelligent agent node's sharing fine-tuning updates of model parameters with other members of the same cluster enhances the robustness of the machine learning models to previously unencountered machine-generated data or a newly evolving data pattern.

An additional aspect of decentralized learning system 100, in accordance with certain embodiments, is inter-cluster communication. With inter-cluster communication, updates of machine learning model parameters in response to previously unseen machine-generated data by one or more intelligent agent nodes of one cluster may be shared with other clusters of decentralized learning system 100. In some embodiments, there is no direct sharing of critical updates; rather, the system shares a predetermined Event ID that indicates to intelligent agent nodes of other clusters any updates to model parameters.

In other embodiments, the information shared among the clusters via inter-cluster communication includes gradient updates Δ\tilde{w}ᵢ, in which the intelligent agent node sharing the update is configured to introduce sparsity (i.e., reducing the amount of non-zero features in a vector or matrix) to the data, or “sparsify” the update. If

$${\overline{w}}_{i}^{( new )}$$

represents the model parameters generated by the i-th intelligent agent node in response to newly collected data and

$${\overline{w}}_{i}^{( old )}$$

represents the parameters prior to retraining the model, then the updates are generated as follows:

$$Δ {\overline{w}}_{i} = {\overline{w}}_{i}^{( new )} - {\overline{w}}_{i}^{( old )} . \qquad EQ . 6$$

The update, upon introducing sparsity, retains only the top K percent of gradients:

$$Δ {\overline{w}}_{i}^{( sparse )} = TopK ( {\overline{w}}_{i} , K \% ) , \qquad EQ . 7$$

Being configured to introduce sparsity into the updates, intelligent agent nodes 102a-102n are able to efficiently communicate updates without overwhelming the network that is supporting decentralized learning system 100, while also ensuring sufficient collaboration that is necessary to maintain the machine learning models' robustness to previously unseen data or newly evolving data patterns.

In accordance with certain embodiments, intelligent agent nodes 102a-102n of decentralized learning system 100 are further configured to self-organize into a generalist-specialist hierarchy within one or more of clusters 202a-202m. An intelligent agent node, operating as a generalist, is configured to train a machine learning model on a broad class of machine-generated data. Operating as a specialist, an intelligent agent node is configured to train a machine learning model on relatively rarely encountered or extreme-case machine-generated data. A generalist model may be flexible and relatively capable of adapting to different scenarios without requiring significant retraining. A generalist model, for example, may be large language models or foundational computer vision models capable of performing diverse tasks (e.g., image classification, object detection). By contrast, a specialist model may be trained for more specific tasks using targeted data tailored to a specific task. For example, a specialist model may be trained exclusively using medical terminology for speech recognition involving healthcare.

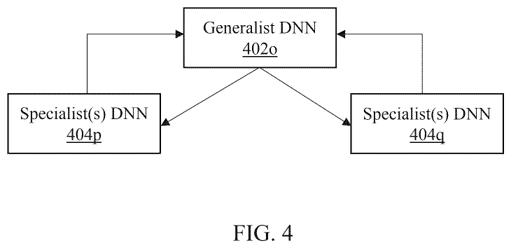

FIG. 4 illustrates a cluster that includes three intelligent agent nodes according to at least one embodiment of the present disclosure. One intelligent agent node is configured to generate a generalist machine learning model, deep neural network 4020, which is trained on a broad class of machine-generated data. The other two intelligent agent nodes are configured to generate different specialist machine learning models, deep neural networks 404p and 404q, respectively, each trained on specifically targeted data that is related to two different specialized machine learning tasks. The feedback loops between the generalist model and each specialist model enhances decentralized learning system 100's ability to generate generalized predictions and specifically targeted ones based on exchanges between deep neural network 4020 (the generalist model) and deep neural networks 404p and 404q (the specialist models, respectively).

In certain embodiments, the generalist model is updated based on parameters of its own model combined with those of each specialist. Consider, for example, a specialist model A in which the model is a deep neural network. The specialist parameters are determined through the iterative application of stochastic gradient descent applied with respect to a specific, or targeted, dataset of specific, specialized, or relatively rarely encountered data,

$${𝒟}_{A}^{rare} :$$

$${w}_{A}^{( specialist )} = {w}_{A} - η {∇}_{{w}_{A}} {ℒ}_{i} ( {w}_{A} , {𝒟}_{A}^{rare} ) . \qquad EQ . 8$$

For a generalist model B, the generalist model is trained based on a weighted sum of the parameters w̅ᵢ generated by each intelligent agent node of the cluster containing the intelligent agent node configured to act as a generalist:

$${w}_{B}^{( generalist )} = \frac{{\sum }_{i ∈ {C}_{k}} {m}_{i} {\overline{w}}_{i}}{{\sum }_{i ∈ {C}_{k}} {m}_{i}} , \qquad EQ . 9$$

where each of the i-th model's parameters w̅ᵢ (a vector) is weighted by the number of samples mᵢ used to train each model.

The intelligent agent nodes configured as generalists may be further configured to fine-tune their generalist models based on a collaborative update:

$${w}_{B}^{( updated )} = {w}_{B}^{( generalist )} + β {w}_{A}^{( specialist )} , \qquad EQ . 10$$

in which the specialists' parameters

$${w}_{A}^{( specialist )}$$

are weighted by a predetermined scalar, β. The collaborative update provided by feedback loops between intelligent agent nodes configured as generalists and those configured as specialists provides distinct advantages to decentralized learning system 100. Decentralized learning system 100 gains targeted learning provided by the respective specialists' models. Decentralized learning system 100 gains robust generalization from the generalist's model. Moreover, as described below, the collaboration between generalist and specialist models can be leveraged to generate an enhanced global machine learning model.

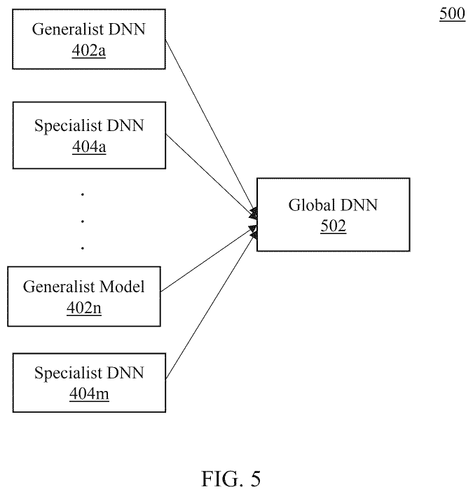

FIG. 5 schematically illustrates output generation 500 of a global machine learning model, deep neural network 502, by intelligent agent nodes 102a-102n configured to collaborate in generating the global model according to at least one embodiment of the present disclosure. Global deep neural network 502 is collaboratively generated by intelligent agent nodes 102a-102n across the clusters 202a-202m of decentralized leaning system 100 each contributing its machine learning model for aggregating the models into a single machine learning model. Illustratively, intelligent agent nodes 102a-102n collectively generate and contribute for aggregation both generalist models, deep neural networks 402a through 402n, and specialist models, deep neural networks 404a through 404m.

In certain embodiments, intelligent agent nodes 102a-102n weight their respective contributions—that is, deep neural networks 402a through 402n, and specialist models, deep neural networks 404a through 404m. The weighting in various arrangements may be based on factors such as the size of the dataset (number of data samples) used to train the models, the importance of the targeted predictions generated by a specialist model, or other factors. Deep neural network 502, as a global model, reflects the learning of each of generalist models, deep neural networks 402a-402n, and specialist models, deep neural networks 404a-404m.

In certain embodiments, in which the set of all models is [symbol] ={M₁, M₂, . . . , Mₙ}, each model's parameters w̅ᵢ (a vector) is weighted as described above by predetermined factors fᵢ (e.g., sample size). The global model's parameters are generated as follows:

$${\overline{w}}_{global} = \frac{{\sum }_{i = 1}^{n} {f}_{i} {\overline{w}}_{i}}{{\sum }_{i = 1}^{n} {f}_{i}} . \qquad EQ . 11$$

where,

fᵢ=α*mᵢ+β*rarity_scoreᵢ, EQ. 12

in which α and β are tunable coefficients to balance sample size and relative rarity of the data. The rarity_scoreᵢ is a metric that quantifies how uncommon or unusual data is relative to other commonly encountered data and may be determined statistically (e.g., number of standard deviations from a dataset mean) or other using other techniques.

As configured for generating a global model, deep neural network 502, intelligent agent nodes 102a-102n of decentralized learning system 100 provide distinct advantages to the system. One advantage is effective integration of both routine and rare data patterns into the global, deep neural network 502. Another advantage is a balanced aggregation of local machine learning models generated by intelligent agent node 102a-102n such that global model 502 reflects contributions of each intelligent agent node's machine learning model.

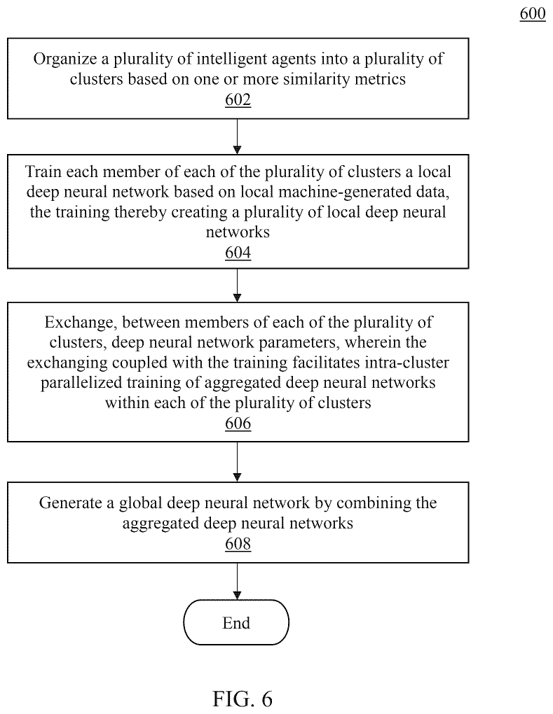

FIG. 6 is a flow diagram of a method 600 of decentralized machine learning according to at least one embodiment of the present disclosure. It will be readily appreciated that not every method step set forth in this flow diagram is always necessary, and that certain steps of the methods may be combined, performed simultaneously, in a different order, or perhaps omitted, without varying from the scope of the disclosure. Method 600 may be performed by information handling systems configured to implement intelligent agent nodes capable of performing various operations such as described with reference to FIGS. 1-5.

At step 602, the intelligent agent nodes are configured to self-organize into a plurality of clusters, the organizing of the clusters based on one or more similarity metrics. Each member of each cluster, at step 604, trains a local deep neural network based on machine-generated data local to each member. The training each cluster's members creates multiple local deep neural networks. At step 606, members of each of the clusters exchange deep neural network parameters with other members of the same cluster. Coupled with the training, the exchange of deep neural network parameters facilitates intra-cluster parallelized training of aggregated deep neural networks within each of the clusters. A global deep neural network is generated at step 608. The global deep neural network is generated by combining the aggregated deep neural networks.

Method 600, in certain embodiments, further includes fine-tuning one or more of the local deep neural networks. The one or more local deep neural networks may be fine-tuned by adjusting at least one deep neural network parameter in response to detecting an anomaly with newly collected machine-generated data. The anomaly may be data that deviates by more than a predetermined threshold from expected data that in a probabilistic sense is considered at least somewhat likely to be encountered. Detection of anomalous data thus may be performed based on statistical measures, clustering techniques, and/or machine learning models configured to quantify how great the deviation between the data and an expected value or norm.

In some embodiments, method 600 identifying a critical update in response to detecting an anomaly within machine-generated data collected by one or more intelligent agent node. The critical update may be communicated to members of other clusters to enable the members to adjust parameters of the aggregated deep neural networks with each of the other clusters. The critical update, in some embodiments, may be communicated as an event identifier or other code indicating an operation that may be performed to update the aggregated deep neural networks. In other embodiments, the critical update may include multiple gradients for performing stochastic gradient descent to update the aggregated deep neural networks. Communicating the critical update to members of other clusters may include introducing sparsity into the critical update. Sparsity may be introduced by selecting a predetermined percentage of the gradients to communicate to the members. The predetermined percentage being less than one hundred, only the top K (a positive integer) gradients are communicated. Sparsity facilitates a reduction in bandwidth usage while ensuring efficient and effective inter-cluster collaboration by members of the clusters.

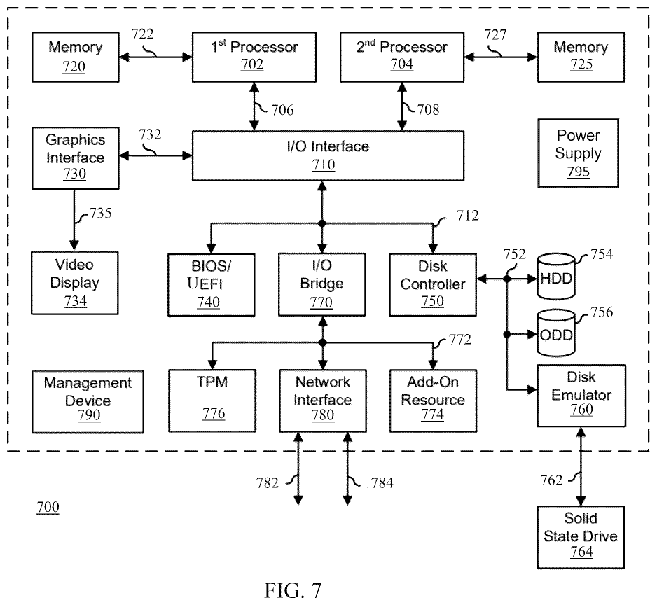

FIG. 7 shows a generalized embodiment of an information handling system 700 according to an embodiment of the present disclosure. Information handling system 700 may be substantially similar to one configured to implement an intelligent agent node, which along with similarly configured information handling systems forms a decentralized machine learning system such as one described with respect to FIG. 1. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 700 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 700 can include processing resources for executing machine-executable code, such as a central processing unit (CPU), a programmable logic array (PLA), an embedded device such as a System-on-a-Chip (SoC), or other control logic hardware. Information handling system 700 can also include one or more computer-readable mediums for storing machine-executable code, such as software or data. Additional components of information handling system 700 can include one or more storage devices that can store machine-executable code, one or more communications ports for communicating with external devices, and various input and output (I/O) devices, such as a keyboard, a mouse, and a video display. Information handling system 700 can also include one or more buses operable to transmit information between the various hardware components.

Information handling system 700 can include devices or modules that embody one or more of the devices or modules described below and operates to perform one or more of the methods described below. Information handling system 700 includes a processors 702 and 704, an input/output (I/O) interface 710, memories 720 and 725, a graphics interface 730, a basic input and output system/universal extensible firmware interface (BIOS/UEFI) module 740, a disk controller 750, a hard disk drive (HDD) 754, an optical disk drive (ODD) 756, a disk emulator 760 connected to an external solid state drive (SSD) 764, an I/O bridge 770, one or more add-on resources 774, a trusted platform module (TPM) 776, a network interface 780, a management device 790, and a power supply 795. Processors 702 and 704, I/O interface 710, memory 720, graphics interface 730, BIOS/UEFI module 740, disk controller 750, HDD 754, ODD 756, disk emulator 760, SSD 764, I/O bridge 770, add-on resources 774, TPM 776, and network interface 780 operate together to provide a host environment of information handling system 700 that operates to provide the data processing functionality of the information handling system. The host environment operates to execute machine-executable code, including platform BIOS/UEFI code, device firmware, operating system code, applications, programs, and the like, to perform the data processing tasks associated with information handling system 700.

In the host environment, processor 702 is connected to I/O interface 710 via processor interface 706, and processor 704 is connected to the I/O interface via processor interface 708. Memory 720 is connected to processor 702 via a memory interface 722. Memory 725 is connected to processor 704 via a memory interface 727. Graphics interface 730 is connected to I/O interface 710 via a graphics interface 732 and provides a video display output 736 to a video display 734. In a particular embodiment, information handling system 700 includes separate memories that are dedicated to each of processors 702 and 704 via separate memory interfaces. An example of memories 720 and 730 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 740, disk controller 750, and I/O bridge 770 are connected to I/O interface 710 via an I/O channel 712. An example of I/O channel 712 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 710 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 740 includes BIOS/UEFI code operable to detect resources within information handling system 700, to provide drivers for the resources, initialize the resources, and access the resources. BIOS/UEFI module 740 includes code that operates to detect resources within information handling system 700, to provide drivers for the resources, to initialize the resources, and to access the resources.

Disk controller 750 includes a disk interface 752 that connects the disk controller to HDD 754, to ODD 756, and to disk emulator 760. An example of disk interface 752 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 760 permits SSD 764 to be connected to information handling system 700 via an external interface 762. An example of external interface 762 includes a USB interface, an IEEE 4394 (Firewire) interface, a proprietary interface, or a combination thereof. Alternatively, solid-state drive 764 can be disposed within information handling system 700.

I/O bridge 770 includes a peripheral interface 772 that connects the I/O bridge to add-on resource 774, to TPM 776, and to network interface 780. Peripheral interface 772 can be the same type of interface as I/O channel 712 or can be a different type of interface. As such, I/O bridge 770 extends the capacity of I/O channel 712 when peripheral interface 772 and the I/O channel are of the same type, and the I/O bridge translates information from a format suitable to the I/O channel to a format suitable to the peripheral channel 772 when they are of a different type. Add-on resource 774 can include a data storage system, an additional graphics interface, a network interface card (NIC), a sound/video processing card, another add-on resource, or a combination thereof. Add-on resource 774 can be on a main circuit board, on separate circuit board or add-in card disposed within information handling system 700, a device that is external to the information handling system, or a combination thereof.

Network interface 780 represents a NIC disposed within information handling system 700, on a main circuit board of the information handling system, integrated onto another component such as I/O interface 710, in another suitable location, or a combination thereof. Network interface device 780 includes network channels 782 and 784 that provide interfaces to devices that are external to information handling system 700. In a particular embodiment, network channels 782 and 784 are of a different type than peripheral channel 772 and network interface 780 translates information from a format suitable to the peripheral channel to a format suitable to external devices. An example of network channels 782 and 784 includes InfiniBand channels, Fibre Channel channels, Gigabit Ethernet channels, proprietary channel architectures, or a combination thereof. Network channels 782 and 784 can be connected to external network resources (not illustrated). The network resource can include another information handling system, a data storage system, another network, a grid management system, another suitable resource, or a combination thereof.

Management device 790 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 700. In particular, management device 790 is connected to various components of the host environment via various internal communication interfaces, such as a Low Pin Count (LPC) interface, an Inter-Integrated-Circuit (I²C) interface, a PCIe interface, or the like, to provide an out-of-band (OOB) mechanism to retrieve information related to the operation of the host environment, to provide BIOS/UEFI or system firmware updates, to manage non-processing components of information handling system 700, such as system cooling fans and power supplies. Management device 790 can include a network connection to an external management system, and the management device can communicate with the management system to report status information for information handling system 700, to receive BIOS/UEFI or system firmware updates, or to perform other task for managing and controlling the operation of information handling system 700.

Management device 790 can operate off a separate power plane from the components of the host environment so that the management device receives power to manage information handling system 700 when the information handling system is otherwise shut down. An example of management device 790 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 790 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An intelligent agent node configured to operate within a decentralized machine learning environment including a plurality of other intelligent agent nodes, the intelligent agent node comprising:
one or more processors;
an input/output interface coupled with the one or more processors and configured to communicate via a peer-to-peer network with the plurality of other intelligent agent nodes; and
a non-transitory, computer-readable storage medium coupled with the one or more processors and storing processor-executable instructions that when executed cause the intelligent agent node to perform operations including:
self-organizing with at least one of the plurality of other intelligent agent nodes into a cluster of intelligent agent nodes whose members include the intelligent agent node and the at least one of the plurality of other intelligent agent nodes, wherein the cluster is formed based, at least in part, on determining a similarity metric for each member of the cluster;
training a local deep neural network based on local machine-generated data; and
exchanging deep neural network parameters with other members of the cluster via the peer-to-peer network, wherein the exchanging facilitates intra-cluster parallelized training of an aggregated deep neural network, and wherein the aggregated deep neural network in combination with other aggregated deep neural networks generated within other clusters forms a global deep neural network.

2. The intelligent agent node of claim 1, wherein the operations further include:
fine-tuning the aggregated deep neural network by adjusting at least one of the deep neural network parameters in response to detecting an anomaly within newly collected machine-generated data.

3. The intelligent agent node of claim 2, wherein the operations further include:
identifying a critical update in response to detecting the anomaly within the newly collected machine-generated data; and
communicating the critical update to members of the other clusters via the peer-to-peer network, wherein the critical update enables adjusting parameters of the other aggregated deep neural networks generated within other clusters.

4. The intelligent agent node of claim 3, wherein the critical update comprises an event identifier indicating an operation to perform to update the aggregated deep neural network.

5. The intelligent agent node of claim 3, wherein the critical update comprises a plurality of gradients for performing stochastic gradient descent, and wherein the operations further include:
introducing sparsity into the critical update prior to communicating the critical update to members of the other clusters,
wherein the sparsity is introduced by selecting a predetermined percentage of the plurality of gradients to communicate to members of the other clusters.

6. The intelligent agent node of claim 1, wherein the similarity metric includes at least one of cosine similarity, gradient similarity, or Kullbach-Leibler divergence.

7. The intelligent agent node of claim 1, wherein the self-organizing is based on at least one resource constraint in addition to the similarity metric.

8. The intelligent agent node of claim 1, wherein the local machine-generated data includes data generated by a sensor operatively coupled via the input/output interface with the one or more processors.

9. A decentralized machine learning system, comprising:
a plurality of intelligent agent nodes, wherein each of the plurality of intelligent agent nodes includes a processor set coupled with a non-transitory, computer-readable storage media to store program instructions, wherein execution of the program instructions causes the plurality of intelligent agent nodes to cooperatively perform operations including:
self-organizing into a plurality of clusters, wherein members of each of the plurality of clusters include two or more of the plurality of intelligent agent nodes clustered based, at least in part, on similarity metrics;
training by each member of each of the plurality of clusters a local deep neural network based on local machine-generated data, the training thereby creating a plurality of local deep neural networks;
exchanging, between members of each of the plurality of clusters, deep neural network parameters, wherein the exchanging facilitates intra-cluster parallelized training of aggregated deep neural networks within each of the plurality of clusters; and
generating a global deep neural network by combining the aggregated deep neural networks.

10. The decentralized machine learning system of claim 9, wherein the operations further include:
fine-tuning at least one of the aggregated deep neural networks by adjusting at least one of the deep neural network parameters in response to detecting an anomaly within newly collected machine-generated data.

11. The decentralized machine learning system of claim 10, wherein the operations further include:
identifying by at least one of the plurality of intelligent agent nodes a critical update in response to detecting the anomaly within newly collected machine-generated data; and
communicating the critical update to members of other of the plurality of clusters, wherein the critical update enables adjusting parameters of the aggregated deep neural networks within each of the plurality of clusters.

12. The decentralized machine learning system of claim 11, wherein the critical update comprises an event identifier indicating an operation to perform to update the aggregated deep neural networks.

13. The decentralized machine learning system of claim 11, wherein the critical update comprises a plurality of gradients for performing stochastic gradient descent, and wherein the operations further include:
introducing sparsity into the critical update prior to communicating the critical update to members of other of the plurality of clusters,
wherein the sparsity is introduced by selecting a predetermined percentage of the plurality of gradients to communicate to members of the other clusters.

14. The decentralized machine learning system of claim 9, wherein the similarity metrics include at least one of cosine similarity, gradient similarity, or Kullbach-Leibler divergence.

15. The decentralized machine learning system of claim 9, wherein the self-organizing is based on at least one resource constraint in addition to the similarity metrics.

16. A method of decentralized machine learning, the method comprising:
organizing a plurality of intelligent agent nodes into a plurality of clusters based on one or more similarity metrics;
training each member of each of the plurality of clusters a local deep neural network based on local machine-generated data, the training thereby creating a plurality of local deep neural networks;
exchanging, between members of each of the plurality of clusters, deep neural network parameters, wherein the exchanging facilitates intra-cluster parallelized training of aggregated deep neural networks within each of the plurality of clusters; and
generating a global deep neural network by combining the aggregated deep neural networks.

17. The method of decentralized machine learning of claim 16, wherein the method further comprises:
fine-tuning at least one of the plurality of local deep neural networks by adjusting at least one of the deep neural network parameters in response to detecting an anomaly within newly collected machine-generated data.

18. The method of decentralized machine learning of claim 17, wherein the method further includes:
identifying by at least one of the plurality of intelligent agent nodes a critical update in response to detecting the anomaly within newly collected machine-generated data; and
communicating the critical update to members of other of the plurality of clusters, wherein the critical update enables adjusting parameters of the aggregated deep neural networks within each of the plurality of clusters.

19. The method of decentralized machine learning of claim 18, wherein the critical update comprises an event identifier indicating an operation to perform to update the aggregated deep neural networks.

20. The method of decentralized machine learning of claim 18, wherein the critical update comprises a plurality of gradients for performing stochastic gradient descent, and wherein the method further comprises:
introducing sparsity into the critical update prior to communicating the critical update to members of the other clusters,
wherein the sparsity is introduced by selecting a predetermined percentage of the plurality of gradients to communicate to members of other of the plurality of clusters.
